(19) United States
(12) Patent Application Publication
(10) Pub. No.: US 2014/0302296 A9
(43) Pub. Date: Oct. 9, 2014

(54) TRANSPARENT CONDUCTIVE FILMS WITH CARBON NANOTUBES, INKS TO FORM THE FILMS AND CORRESPONDING PROCESSES

(71) Applicant: C3NANO INC., Hayward, CA (US)

(72) Inventors: Melburne C. LeMieux, San Jose, CA (US); Ajay Virkar, Mountain View, CA (US); Yung-Yu Huang, Palo Alto, CA (US)

(73) Assignee: C3NANO INC., Hayward, CA (US)

(21) Appl. No.: 13/625,184

(22) Filed: Sep. 24, 2012

(51) Int. Cl. H01B 1/04

(52) U.S. Cl. CPC H01B 1/04; Y10S 977/742; Y10S 977/752; B82Y 30/00
USPC 428/220; 252/502; 252/510; 252/511; 252/506; 428/336; 977/742; 977/752; 977/734

(57) ABSTRACT

Inks for the formation of transparent conductive films are described that comprise an aqueous or alcohol based solvent, carbon nanotubes as well as suitable dopants. Suitable dopants generally comprise halogenated ionic dopants. In some embodiment, the inks comprise sulfonated dispersants that can effectively provide additional doping to improve electrical conductivity as well as stabilize the inks with respect to settling and/or improve the fluid properties of the inks for certain processing approaches. The inks can be processed into films with desirable levels of electrical conductivity and optical transparency.

### FIELD OF THE INVENTION

The invention relates to inks comprising well dispersed carbon nanotubes with stable and effective ionic dopants and optionally with dopant polymers, films formed from such inks and corresponding processes to form the inks, deposit the inks and form films from the inks. The films are useful as transparent conductive films.

### BACKGROUND OF THE INVENTION

Transparent conductive films find significant commercial applications, and with the growing use of displays, commercial applications are likely to grow significantly into the foreseeable future. Conductive metal oxides have found commercial use for transparent conductive films. In particular, tin-indium oxide (ITO), antimony-tin oxide (ATO), fluorine-doped tin oxide (FTO), aluminum-doped zinc oxide (AZO) and the like are conductive metal oxides suitable for use in transparent conductive films. The conductive metal oxides can be deposited using physical vapor deposition process, such as sputtering, ions plating and vacuum deposition, that are generally based on relatively expensive capital intensive equipment. Advanced materials can take advantage of physical properties of submicron structures to effectively generate electrically conductive films with these submicron conductive materials.

Carbon nanotubes are a promising nanomaterial with interesting properties. Carbon nanotubes (CNTs) have a potential to be the cornerstone of future electronics due to a superior combination of properties: they are 1000 times more electrically conductive than ITO, they are 100 times stronger than steel while being 10 times lighter, and due to their nanoscale dimensions, they can be transparent and can be bent and flexed without reduction in these values. These materials have not yet reached significant commercial application due to complexities in forming realistic commercial devices that take advantage of the promising properties of the nanotubes. Most importantly, CNTs are abundant, and already cheaper than ITO, making them an excellent candidate material for ITO replacement in transparent electrodes.

Transparent electrodes are a central component in many electronic devices, such as displays, touch screens, e-paper, and solar cells. The term electrode refers to a high conductivity material which can transport electrons (or holes) efficiently. Transparent electrodes are necessary for devices where light must be able to pass through a film, and high conductivity is necessary (such as displays, solar cells, and touch screens). The current state of the art transparent electrode is Indium Tin Oxide (ITO) for these applications. Replacing ITO is imperative due to the scarcity and cost of ITO. Moreover, ITO is brittle and inflexible, severely limiting its potential usage in next generation flexible electronics.

### SUMMARY OF THE INVENTION

In a first aspect, the invention pertains to an ink for the formation of a transparent electrically conductive film coating comprising an alcohol based solvent or water based solvent, carbon nanotubes, a sulfonated dispersant and an ionic dopant composition. In particular, the ink can comprise from about 25 to about 2000 micrograms/milliliter (μg/ml) well dispersed carbon nanotubes, from about 0.025 to about 5 weight percent sulfonated dispersant, and from about 0.1 to about 10 milligrams/ml (mg/ml) an ionic dopant composition, fluorinated fullerenes or a combination thereof. In some embodiments the ionic dopant composition comprises a perhalogenated inorganic anions, trifluorosufonimide anions, trifluoromethanesulfonate anions or combinations thereof.

In further aspects, the invention pertains to an ink for the formation of a transparent electrically conductive film coating comprising an aqueous based solvent or an alcohol based solvent, from about 0.025 wt % to about 5 wt % well dispersed carbon nanotubes and from about 0.01 wt % to about 2wt % inorganic salt comprising MSbF₆, MSbCl₆, MBF₄, MBCl₄, MPF₆, MPCl₆ or a combination thereof, where M is a monovalent metal cation, or organic cation.

In additional aspects, the invention pertains to an ink for the formation of a transparent electrically conductive film coating comprising an alcohol based solvent comprising at least about 85 volume % alcohol, from about 0.025 wt % to about 5 wt % well dispersed carbon nanotubes and from about 0.01 wt % to about 2wt % dopant comprising trifluoromethanesulfonate anions or trifluoromethanesulfonimide anions.

In other aspects, the invention pertains to a transparent electrically conductive film comprising a layer having carbon nanotubes and an ionic dopant composition with a perhalogenated anion with at a weight ratio of nanotubes to ionic dopant composition from about 0.01 to about 1, wherein the layer has an average thickness from about 2 nanometers (nm) to about 250 nm, a surface resistance of no more than about 500 ohms/sq., and a percent transmission through the film at 550 nm of at least about 85%. Suitable devices can be formed incorporating such films.

Moreover, the invention pertains to a method for the formation of a carbon nanotube ink, the method comprising the forming of a blend with a good (stable over time) dispersion of carbon nanotubes and an ionic dopant composition having a polyatomic halogenated inorganic anion, a trifluoromethanesulfonate, a trifluoromethanesulfonimide or a combination thereof

### BRIEF DESCRIPTION OF THE DRAWINGS

FIG. 1 is a histogram plotting average sheet resistances for three types of CNT based films.

FIG. 2 is a plot of sheet resistance as a function of acidity from different sulfonic acid based polymers.

FIG. 3 is a plot of sheet resistances as affected by acidity and dispersant molecular weights.

FIG. 4 is an atomic force microscopy image of carbon nanotubes formed into a film without a polymer dispersant.

FIG. 5 is an atomic force microscopy image of a film formed with carbon nanotubes with a dopant dispersant with an ionic dopant.

FIG. 6 is a histogram plotting sheet resistances for spray coated CNT films formed with or without an ionic dopant, showing the effects of dopant without the dopant dispersant.

FIG. 7a is a histogram plotting relative change in surface resistance for a first set of CNT based films having different dopant combinations and/or concentrations.

FIG. 7b is a histogram plotting relative change in surface resistance for a second set of CNT based films having different dopant combinations and/or concentrations.

FIG. 8 is a histogram plotting sheet resistance and percent transmission for CNT based films with different dopant compositions to improve the performance and stability of fluorinated fullerene dopant.

FIG. 9 is a plot of sheet resistances for CNT based films having a percent transmission of about 84% as a function of amount of dopant dispersant in the conductive ink.

### DETAILED DESCRIPTION

Transparent conductive films based on carbon nanotubes (CNTs) can be formed with improved dopants, dispersants and dopant combinations to provide significant improvements in coatability and stability of the conductive ink while maintaining desirable performance properties in the resulting coated films. In some embodiments, desirable dopants comprise ionic dopants with perhalogenated anions, which in some embodiments have selected metal cations, and in further embodiments functionalized fullerenes are used as dopants. In additional or alternative embodiments, the CNT-based films comprise dispersant dopants, e.g., perfluorinated and/or sulfonated polymers, surfactants or the like, that can provide both desirable rheological and dispersive properties of the ink as well as additional doping for the carbon nanotubes to further increase film performance. Inks with both a dispersant dopant and a second dopant provide a synergistic amount of performance and stability with respect to the maintenance of the desirable properties following film formation. The rheological properties of the CNT inks can be adjusted to provide for a desired modality for deposition that can be commercially relevant, for example, slot-die, gravure, inkjet, spray coating and the like. The resulting CNT-based films can be formed to provide high levels of electrical conductivity as well as good levels of transparency with respect to visible light. The transparent conductive films can be formed directly onto a substrate or onto a polymer sheet (film) acting as a substrate. The transparent conductive films are suitable for various applications that effectively use an electrically conductive film substantially transparent to visible light.

The primary issue concerning nanotubes as ITO replacements to date is inferior conductivity, and we address this issue herein by using an effective combination of a multifunctional dispersant that also acts as a p-type dopant to the CNTs, along with specific dopants as described above. Thus, the carbon nanotube based films can be used as suitable replacements for ITO transparent conductive coatings.

Carbon nanotubes have generally cylindrical walls made up of a hexagonal lattice of carbon atoms analogous to carbon in graphene sheets with a hollow core. A carbon nanotube can comprise a single graphene layer forming the wall (“single wall carbon nanotubes”, SWNT), two graphene layers (“double wall carbon nanotube”, DWNT) or more than two graphene layers in the walls concentrically arranged about a common long axis (“multiwalled carbon nanotubes”, MWNT). Also, few wall carbon nanotubes (FWNT) can be specified as carbon nanotubes with a majority, e.g., at least 60 number percent, of the nanotubes having three graphene layers or four graphene layers. As described further below, in some embodiments it is desirable for the carbon nanotubes used in electrically conductive inks and films to have a majority DWNT, FWNT or a combination thereof. Carbon nanotubes are generally characterized by an outer diameter and a length along with the nature of the nanotube wall structure and other properties, such as electrical conductivity and chirality.

Various properties of the carbon nanotubes are a function of the synthesis of the nanotubes. Of course, the synthesis method determines the majority wall thickness, e.g., SWNT, DWNT, FWNT or MWNT. However, synthesis also influences properties, such as the degree of functional groups on the nanotubes, chirality distribution, amount of residual catalyst, impurities besides catalyst, length of the nanotubes, bundle diameter of the nanotube bundles and defect density. The properties of the nanotubes significantly influence the electric conductivity of the carbon nanotubes, which is an important property with respect to the formation of the conductive films as described herein. CNT properties are generally selected to provide good electrical conductivity. Carbon nanotubes are available from various commercial suppliers using various synthesis approaches. In general, it is desirable for the CNTs to be relatively uniform with respect to wall thickness, such as at least 60% of the CNTs being double wall nanotubes.

The synthesis of the carbon nanotubes also significantly influences the processability of the nanotubes. In particular, the processing to form films involves the debundling of the as synthesized carbon nanotubes. The processing can be designed such that the debundling does not undesirably decrease the average nanotube length or introduce excessive defects. With respect to processing using more commercially robust processing, it has been found that DWNTs and FWNTs are particularly desirable for reducing defects and maintaining nanotube lengths during debundling and dispersion of the nanotubes. Surprisingly, the use of DWNT and FWNTs does not undesirably diminish the transparency or electrical conductivity of resulting films. Also, DWNTs and FWNTs can be effectively used with the improved dopants and combination of dopants described herein. Thus, DWNTs, and in some embodiments FWNTs, in particular are desirable for certain applications by providing a balance of good electrical conductivity, especially when used with the improved dopants described herein, along with excellent processability as described herein.

In general, a carbon nanotube film can comprise desired dopants and dopant combinations in combination with single wall carbon nanotubes, double wall carbon nanotubes, few wall nanotubes, multiple wall carbon nanotubes or any combination thereof. The electrical and optical properties of carbon nanotubes can be a function of the diameter. In particular, carbon nanotubes with smaller diameters generally have a reduced electrical resistance for a given length and defect level, although an inherent electrical conductivity may or may not be effectively transferred to a property of a product film. Also, optical transparency of a film formed with CNTs is influenced by the carbon nanotube diameters. Due to their more desirable electrical and optical characteristics, a carbon nanotube composite can comprise carbon nanotubes with a relatively small diameter, such as an average diameter of no more than about 10 nanometers (nm), to obtain improved properties for resulting films. To reduce defects and breaking of CNTs during processing into a film, it has been found that DWNTs and FWNTs can provide desirable features for film formation.

Carbon nanotubes have been identified as potential candidate materials for the formation of transparent conductive films. A relatively early description of the use of single wall carbon nanotubes in for transparent conductive films is described in U.S. Pat. No. 7,060,241 to Glatkowski, entitled “Coatings Comprising Carbon Nanotubes and Methods for Foaming Same,” incorporated herein by reference. By dispersing single wall nanotubes and forming films from these, the Glatkowski patent achieved sheet resistances of roughly 10⁵ ohms/square (Ω/□) with moderate optical transparency. In contrast with the Glatkowski films, the materials described herein generally comprise one or more dopants that provide improved performance while also stabilizing the material for long term use and while maintaining desired degrees of transparency. In some embodiments herein, DWNTs and/or FWNTs are effectively used to obtain superior processability while maintaining excellent optical transparency and electrical conductivity. In particular, the desired inks can comprise an ionic dopant with halogenated anion, as described further below, and the ionic dopant can be combined optionally with a dispersant dopant and/or a fullerene-based dopant to provide synergistic improvements in performance. Dispersant dopants can also be effective as a dispersing and deposition aid. Thus, practical CNT inks are described that are convenient for commercial processing of transparent conductive films with good performance with respect to electrical conductivity and transparency, while providing stable performance.

Classes of ionic dopants are identified herein that provide synergistic improvements in the properties of the CNT-based films that are formed from corresponding inks. In particular the ionic dopants can provide unexpected improvements in the properties of the resulting films and/or unexpectedly improve the stabilities of the materials. The complex halogenated anions of the ionic dopants can be, for example, inorganic anions, trifluoromethanesulfonate anions, trifluoromethanesulfonimide, or combinations thereof. In some embodiments, for doping functions, the ionic dopants can comprise a metal cation, such as a silver cation, lithium cation or the like. In certain embodiments where the dopants comprise fluorinated fullerene, the metal cations of lithium and/or sodium can be used for stabilization of the overall ink formulation. In general, monovalent cations are generally of particular interest for use with the dopant anions. Based on the results obtained with these materials, the nature of both the cation and the anion are significant with respect to properties of the films. The roles of the cations and anions are not fully understood, and the disclosure herein is not intended to be limited by theory.

Dopants with organic cations and complex inorganic anions have been previously described. In particular, triethyloxonium cations ((C₂H₅)₃O⁺) have been identified as the cation to form compositions with hexachloroantimonate anions (SbCl₆⁻). See generally, Rathore et al., “Preparation and Structures of Crystalline Aromatic Cation-Radical Salts. Triethyloxonium Hexachloroantimonate as a Novel (One-Electron) Oxidant,” J. Organic Chemistry 63: 5847-5856 (1998), incorporated herein by reference. Triethyloxonium hexachloroantimonate has been identified as a dopant for carbon nanotubes as described in U.S. Pat. No. 7,253,431 to Afzali-Ardakani et al., entitled “Method and Apparatus for Solution Processed Doping of Carbon Nanotube,” incorporated herein by reference. The use of (trifluoromethane)sulfonimide based dopants for carbon nanotubes is described generally in published U.S. patent application 2011/0086176 to Yoon et al., entitled “Carbon Nanotube Having Improved Conductivity, Process of Preparing the Same, and Electrode Comprising the Carbon Nanotube,” incorporated herein by reference.

While the ionic dopants may be effectively used alone as dopants for CNT-based films, desirable results can be obtained with combinations of dopants. The improved dopants described herein provide surprising performance improvements with respect to electrical conductivity and stability of these inks over time without negative impact on the optical transparency. The specific formulation can depend on the desired properties of both the associated CNT ink to be deposited to form the CNT-based film as well as the desired properties of the films. In some embodiments, the inks and corresponding films comprise a dispersant, which can be selected to be a dopant itself for the CNTs. In further embodiments, the inks and films comprise fluorinated fullerene dopants, which are a very effective dopant for CNTs. Combinations of dopants and/or stabilization agents have been found to provide synergistic improvements in one or more aspects of performance, such as desirable levels of electrical conductivity with good transparency and/or stability of the inks and/or coating.

The use of halogenated fullerenes as a dopant to increase the electrical conductivity of carbon nanotubes and other nanostructured materials is described in published U.S. patent application 2011/0204319 to Virkar et al., entitled “Fullerene-Doped Nanostructures and Methods Therefore,” incorporated herein by reference. The use of these doped halogenated fullerene materials or other molecular joining materials for the formation of structures and corresponding devices is described in published U.S. patent application 2011/0204330 to LeMieux et al., entitled “Joined Nanostructures and Methods Therefore,” incorporated herein by reference. Improved dopants are described herein that can be used alone or in combination with the halogenated fullerenes. As noted herein, the improved combination of dopants can provide desirable electrical conductivity, transparency and stability over time.

Ion conductive polymer binders for carbon nanotube films have been described in published U.S. patent application 2010/0136343 to Chang et al. (the '343 application), entitled “Composition Including Carbon Nanotubes and Transparent and Conductive Film,” incorporated herein by reference. As described in the '343 application, the ion conductive polymer binders can be fluorinated polymers with sulfonyl groups. It has been discovered that a combination of ion conductive polymers with an improved ionic dopant as described herein can provide synergistic improvement in the properties of the resulting transparent conductive films. Nalion®, a sulfonated polytetrafluoroethyelene based copolymer, is a particular example of a polymer that provides suitable dopant to the nanotubes, although other sulfonated polymers and sulfonated surfactants can provide desired dispersion and doping effects.

The improved transparent conductive films comprise carbon nanotubes and an ionic dopant as described herein. The transparent conductive films can further comprise a dispersant dopant, which can stabilize the film as well as provide processing advantages with respect to some approaches for forming the film. In particular, perfluorinated polymers or surfactants with sulfonated groups can provide convenient ink properties when formulated with the CNT inks and these can further provide dopants to the CNTs. In this way, the dispersant is multifunctional, acting as an efficient dispersant/stabilizer of the CNTs in solution, while providing doping effects, thereby increasing the overall electrical conductivity of the resulting film. Since the class of polymers can provide a dopant to the carbon nanotubes, it is surprising that the combination of the dopant polymer with another dopant source can significantly improve performance of the resulting transparent conductive films. The combination of the dispersant dopant with the ionic dopant involves some balancing of processing conditions to achieve the performance enhancement. In a stable dispersion, the dispersant can be selected to be compatible with both the CNTs to be dispersed as well as the solvent. It has been surprisingly found that dispersant dopants with lower molecular weights in particular lead to desirable properties of resulting films. It has been found that generally with lower molecular weight polymer dispersants or surfactants, a lower amount of dispersant by weight will be used to form a stable dispersion, and the formation of a film with lower quantities of polymer dispersants can enhance electrical conductivity in two ways: 1) by interfering less with CNT junctions allowing more intimate contact between the CNT conductive elements of the film, and 2) by allowing for more additional dopant to interact with CNT sidewalls. CNTs that are more completely associated with a polymer dispersant generally are observed to be less effected by ionic dopants, as is observed in the examples below.

The films can further comprise fluorinated fullerenes in addition to or as an alternative to the ion conductive polymers. Also, the films can comprise one or more other types of polymer dispersants in addition to or as an alternative to the sulfonated polymers. A polymer can also increase the viscosity of an ink that can be printed to form a conducting film. Thus, for inks to be deposited using techniques involving a higher viscosity, the polymers can serve multiple functions.

The dispersant dopants are convenient for the formation of practical inks that can be used for the deposition to form desired structures. Inks generally refer to dispersions comprising well dispersed carbon nanotubes and a dopant with desirable properties for deposition using a selected technique. In some embodiments, the inks can comprise an alcohol solvent. It has been found that nanoparticle inks comprising at least about 95 weight percent alcohol solvents can be used to form films with more desirable properties with the ionic additives described herein. Concentrations and additives can be selected to influence the properties of the inks.

In general, the inks can be prepared for deposition using suitable approaches for commercial applications. In general, the deposition approaches can comprise coating approaches and/or printing approaches. Suitable coating (printing) methods include, for example, slot-die, gravure, knife edge/blade bar coating, inkjet, screen printing and the like. Solvents, concentrations and additives can be added and adjusted to achieve appropriate ink properties.

In general, it is desirable to form films with low electrical resistance and high optical transparency. Electrical resistance is generally evaluated as a sheet resistance, which is reported in units of ohms per square (Ω/□). Sheet resistance is measured as electrical resistance along the surface. With the improved materials described herein, the carbon nanotube films can have a sheet resistance of about 1 to about 500Ω/□, depending on the optical transmissivity. This sheet resistance range falls within desirable values for the majority of display applications and other commercial applications of particular interest. Optical transparency can be evaluated at 550 nm wavelength as a representative wavelength, and approximately the middle of the visible spectrum. In films described herein, the films with low sheet resistance can simultaneously have an optical transparency at 550 nm of at least about 85%. Thus, the carbon nanotube films can be effective as transparent conductive layers.

In general, transparent conductive coatings can be suitable for a range of applications. In particular, various display structures can be effectively formed with a transparent conductive coating, such as liquid crystal displays, plasma displays, touch panels or the like. Other suitable applications for transparent conductive layers include, for example, solar cells, organic light emitting diodes, antistatic coatings, electromagnetic interference shielding or the like. The improved transparent conductive films described herein can be correspondingly used to provide improved performance of the corresponding products. The carbon nanoparticles materials can be formed into the desired transparent conductive films using commercially suitable processes for cost effective processing for commercial production.

### Carbon Nanotubes

The transparent conductive films comprise carbon nanotubes as the fundamental electrically conductive material. Carbon nanotubes can be produced by a variety of methods and, additionally, are widely commercially available from sources. Carbon nanotubes can be synthesized using many synthesis techniques well known in the art including, but not limited to, laser vaporization of graphite, arc discharge, high pressure carbon monoxide processes, chemical vapor deposition, and catalytic growth processes. Depending on the synthetic method, as synthesized carbon nanotubes can be capped at one or both ends by a hemispherical portion of a fullerene-like molecule such that the end of the carbon nanotube comprises a hemispherical structure comprising five-membered rings.

Carbon nanotube conductivity can range from metallic to semiconducting based upon their structural properties. For example, nanotube diameter can significantly affect the conductivity of carbon nanotubes. In particular, curvature effects at small nanotube diameters can strongly influence the band gap structure of the nanotube, especially at small nanotube diameters. For forming conductive transparent films, electrically conductive carbon nanotubes with relatively small diameters can be effectively used to increase electrical conductivity. For improved electrical conductivity of films, it is desirable for the carbon nanotubes to have a longer length, although there are practical limits in current synthesis approaches for forming carbon nanotubes with respect to generating long lengths.

To achieve the desired higher electrical conductivity, the carbon nanotubes can be single wall nanotubes, double wall nanotubes, few wall nanotubes, e.g. three or four walls of average thickness, or combination thereof. Multiwall nanotubes can have a layered structure or a wound structure depending on the synthesis route. In some film/ink embodiments, the carbon nanotubes have an average diameter/outer diameter of no more than about 20 nm, in further embodiments no more than about 10 nm and in still further embodiments, from about 1 nm to about 8 nm. Furthermore, in embodiments of interest herein, the carbon nanotubes have an average length of at least about 500 nm, in further embodiments from about 750 nm to about 15 microns, and in additional embodiments from about 1 micron to about 12 microns. It has been discovered that DWNTs and FWNTs can be desirable for certain applications by providing excellent electrical conductivity after processing. Thus, for some embodiments, it is desirable for the compositions and structures to be at least about 60 number percent DWNTs, FWNTs or combinations thereof, in additional embodiments at least about 75% and in further embodiments at least about 90 number percent to be DWNTs, FWNTs or a combination thereof. A person of ordinary skill in the art will recognize that additional ranges of average diameters, average lengths and proportion of nanotube morphologies within the explicit ranges above are contemplated and are within the present disclosure. Within the desired nanotube parameters, various commercial nanotubes can be tested for desirable electrical conductivity. Commercial carbon nanotube suppliers include, for example, Chengdu Organic Chemicals Co., Ltd. (China), Hanwha Nanotech (Korea), Nanoshel (India), Continental Carbon Corp. (TX, U.S.A.), SES Research (TX, U.S.A.), Yunnan Guorui Nano-tech Co., Ltd. (China), American Dye Source, Inc. (Canada), Arry International Group Limited (Germany), Carbon Nano Materials R&D Center (China), Carbon Nanotechnologies Inc. (U.S.A.) and many others.

### Carbon Nanotube Inks and Deposition Techniques

The carbon nanotube inks can comprise a polar solvent-based solvent system, such as water-based, alcohol-based or solvent combinations thereof, carbon nanotubes, and one or more dopants, generally including an ionic dopant. The inks can further optionally comprise processing aids such as a viscosity modifier and/or a non-dopant polymer. Ionic dopants with complex halogenated anions have been found to be effective dopants, such as perhalogenated inorganic anions, trifluoromethanesulfonimide anion, trifluoromethanesulfonate anion, or combinations thereof. In particular, surprisingly good properties have been obtained with mixtures of dopant types. Specifically, good results are found with a combination of a ionic dopants and a dispersant dopant and/or fluorinated fullerenes dopants. Dispersant dopants include, for example, a perfluorinated and/or sulfonated polymer (“perfluorinated/sulfonated polymer”) and/or a sulfonated surfactant, which can be perhalogenated. The carbon nanotube inks are formed from good dispersions of carbon nanotubes along with a blend of the selected dopants. For particular printing or coating deposition approaches, the ink can comprise additional compatible additives to adjust the ink properties, such as viscosity or surface tension.

In some embodiments, the alcohol-based solvent generally comprises at least about 90 weight % (“wt %”) alcohol, in further embodiments at least about 92.5 wt % alcohol, in other embodiments at least about 95 wt % alcohol and in additional embodiments at least about 99 wt % alcohol. The alcohol can be essentially pure alcohol, with a low level of impurities. An essentially pure alcohol may or may not be dried to remove water. Suitable alcohols include, for example, low molecular weight alcohols, e.g., an alcohol comprising no more than about 6 carbon atoms with a boiling point of no more than about 180° C. Alcohols of interest include, for example, ethanol, isopropyl alcohol, 2-butanol, isobutanol, and mixtures thereof. In other embodiments, water-based solvents can be used that comprise at least 50 wt % water up to 100% water solvent. A person of ordinary skill in the art will recognize that additional ranges of solvent concentrations within the explicit ranges above are contemplated and are within the present disclosure.

The carbon nanotube ink generally comprises from about 0.025wt % to about 10 wt % carbon nanotubes, in further embodiments from about 0.05wt % to about 8wt % and in other embodiments from about lwt % to about 5wt % carbon nanotubes. A person of ordinary skill in the art will recognize that additional ranges of carbon nanotube concentrations within the explicit ranges above are contemplated and are within the present disclosure. The carbon nanotube dispersion can be formulated to have well dispersed nanotubes that are relatively stable to settling, as described further below.

The nanotube coating compositions generally comprise one or more ionic dopants with halogenated anions. Ionic dopants are intended to exclude surfactants and polymers which solubilize in different ways from the ionic dopants. Suitable anions include, for example, inorganic perhalogenated inorganic anions, trifluoromethanesulfonate anions, trifluoromethanesulfonimide anions or combinations thereof. Perhalogenated inorganic ions include, for example, PF₆⁻, BF₄⁻, SbF₆⁻, PCl₆⁻, BCl₄⁻, SbCl₆⁻, or combinations thereof. In particular, the antimonate (SbF₆⁻ and SbCl₆⁻) salts have been found to be very effective, as described in the Examples below. The metal cation can also influence the properties of the resulting film, and a wide range of metal cations, especially monovalent cations, are suitable for the solutions, such as Ag⁺, Li⁺, Na⁺, K⁺, combinations thereof or the like. Silver cations have been found to be effective as a dopant for the carbon nanotubes, while alkali metal cations have been found to stabilize properties of films that also comprise a fluorinated fidlerene dopant. Trifluoromethanesulfonate anions (CF₃SO₃⁻) are also referred to as triflate anions. Trifluoromethanesulfonimide can also be supplied as trifluoromethanesulfonimide acid ([(CF₃SO₂)₂N]H). Organic cations can also be effective in the dopant compositions. For example, suitable organic cations include trialkyloxonium cations, sulfonium cations (R₁, R₂R₃S⁺, where R₁, R₂, R₃ are alkyl derived functional groups), iodonium cations (RₐIR_{b}⁺, where Rₐ and R_{b} are alkyl derived functional groups), or combinations thereof. In particular, triethyloxonium cations ((C₂H₅)₃O⁺), in combination with the dopant anions have been found to be very effective for the formation of transparent conductive films as described in the example. The coating solutions can comprise from about 0.01 mg/ml to about 2 mg/ml ionic dopants salts, in further embodiments from about 0.025 mg/ml to about 1.5 mg/ml and in additional embodiments from about 0.05 mg/ml to about 1 mg/ml ionic dopants. A person of ordinary skill in the art will recognize that additional ranges of metal salt concentrations within the explicit ranges above are contemplated and are within the present disclosure.

To summarize desirable ionic dopants, the following table provides genus of dopant along with some specific species of interest, although other suitable species within the genus clearly follow from the discussion herein.

TABLE 1

| Dopant Group | Dopant Class | Dopant Examples* |
|---|---|---|
| Antimonates | Hexafluoroantimonate (HFA) | Ag-HFA |
| | | Na-HFA |
| | Hexachloroantimonate (HCA) | Triethyloxonium- |
| | | HCA (TOCA) |
| Sulfonates | Trifluoromethansulfonates (TMS) | Ag-TMS |
| | | Li-TMS |
| | | Na-TMS |
| | | K-TMS |
| Sulfonimides | Trifluoromethanesulfonimide | TFMS |
| | (TFMS) | Li-TFMS |
| | | Ag-TFMS |
| Fullerenes | Fluorinated fullerenes (FF) | C₆₀ F₄₈ |
| | | C₆₀ F₃₆ |
| | | C₆₀ F₁₈ |
| | | C₇₀ F₅₄ |

To improve dopant stability under high humidity conditions, it has been found that certain dopant combinations are desirable. These dopant combinations are described further in the Examples below.

In some embodiments, the ink can also comprise a perfluorinated and/or sulfonated dispersant. The perfluorinated/sulfonated dispersant can stabilize the dispersions as well as act as viscosity modifier, dopant and/or binder for the inks and corresponding films formed from the carbon nanotube inks. In general, the perfluorinated/sulfonated (perfluorinated and/or sulfonated) dispersant can comprise a polymer, surfactant or mixtures thereof Sulfonated compositions have a sulfonate (—SO₃⁻) functional group, which can be protonated to form a sulfonic acid group, and the degree of protonation generally depends on the pH of the solution. In some embodiments, dispersants can have a molecular weight of at least 250 g/mole, in further embodiments at least about 400 g/ mole, and in additional embodiments from about 500 g/mole to about 500,000 g/mole. It can be desirable in some embodiments to have lower molecular weight polymers, such as from about 5,000 g/mole to about 30,000 g/mole. Similarly, a reduced sheet resistance is observed for polymers with a greater portion of sulfonate groups in a copolymer composition, although other properties of the product film may suggest different portions of sulfonate groups. In some embodiments, the polymer can comprise at least 50% of monomers of polymerized monomer units comprises a sulfonate group up to 100% of the monomer units. A person of ordinary skill in the art will recognize that additional ranges of molecular weights and compositions within the explicit ranges above are contemplated and are within the present disclosure.

In particular, perfluorinated/sulfonated polymers have been found to be excellent dispersants for carbon nanotubes in alcohol-based solvents. Suitable polymers include, for example, oligomers, and generally suitable polymers can be dimers, trimers, other oligomers with 3-6 repeat groups and non-oligomeric polymers with 7 or more repeat groups. Of course, the polymers can be further specified according to molecular weights as noted in the previous paragraph. Sulfonated polymers can have desirable electrical conductivities and optical transparencies such that films comprising these dispersants can have desirable electrical and optical properties (i.e. the dispersant does not have to be removed from the film in order for the film to have the desirable surface resistances and transparencies described herein). Moreover, sulfonic acid-based polymers can also function as a dopant source such that the surface resistance of a film comprising the polymer is lower than the corresponding film not comprising the sulfonated polymer.

Examples of effective doping and dispersing sulfonated polymers include, for example, poly(styrene-co-4-styrene sulfonic acid), poly(2-acrylamido-2-methylpropanesulfonic acid, poly(styrene sulfonic acid), poly(2-acrylamido-2-methylpropane sulfonic acid-b-acrylic acid), sulfonated polyether ether ketone (S-PEEK), and the like. Poly fluoro sulfonated polymers, such as Nafion® (is a sulfonated polytetrafluorethylene (PTFE) copolymer) and analogs thereof, are also effective as a dispersing and doping polymer. The polymers can be characterized by the percent of the pendant functional groups that are functionalized with sulfonate groups, for example, sulfonic acid. While increased doping and corresponding electrical conductivity can be associated with increases in sulfonate functionalization, an increase in sulfonate functionalization can result in an increase in water uptake at high temperature and high humidity that can degrade performance under these conditions. The results presented in the Examples below indicate that the ability to dope the carbon nanotubes and decrease the sheet resistance is observed for roughly greater than 50% acid functionality. However, the stability of performance at high humidity, which can be evaluated at 65° C. and 90% relative humidity by measuring the change in resistivity, has been found to degrade rapidly with increasing acid content.

In addition to sufonated polymers, suitable dopant disperants also include, for example, sulfonated surfactants. Surfactants generally comprise a hydrophobic chain with a hydrophilic head group, which can be the sulfonate group that can function as a dopant for CNTs. In general, the surfactants have at least 4 carbon atoms in the hydrophobic tail or chain. The hydrophobic chain may or may not be halogenated. Commercially available perhalogenated sulfonated surfactants include, for example, perfluorooctylsulfonate or perfluorobutylsulfonate and non halogenated sulfonated surfactants include, for example, sodium dodecylbenzene sulfonate. Combinations of surfactants can be used as desired.

Results have also been found that are consistent with moderate molecular weight dispersant polymers having improved dopant function while still providing desirable dispersing within the resulting ink. In general, the addition of excessive polymer dispersant can lower performance of the resulting film or coating since the polymer is an electrically insulating material. Polymers with higher molecular weights seemed to be less effective with respect to doping.

In general, dopant dispersants can be used to modify the rheological properties of the carbon nanotube ink such that it is adapted to particular deposition approaches. For example, a dopant dispersant can be used to adjust the surface tension and the viscosity of the ink to achieve desirable coating or printing properties, as described below. Additionally or alternatively, the dopant dispersant can be selected to promote desirable levels of mechanical stability to films formed from the deposited carbon nanotube inks. In some embodiments, a carbon nanotube ink can comprise a dopant dispersant, e.g., a perfluorinated/sulfonated polymer, a sulfonated surfactant or a combination thereof, concentration from about 0.025 wt % to about 5 wt %; in other embodiments, from about 0.05 wt % to about 3.5 wt %; in further embodiments from about 0.1wt % to about 2.5 wt %. A person of ordinary skill in the art will recognize that additional ranges of dopant dispersant concentrations within the explicit ranges herein are contemplated and are within the present disclosure.

The carbon-nanotube ink can also comprise a non-dopant binder alone or in combination with a dopant dispersant. A non-dopant binder can be desirable when the carbon nanotube ink does not comprise a perfluorinated/sulfonated polymer or wherein desirable film dopant levels preclude the use of a perfluorinated/sulfonated polymer in concentrations desirable for a binder. For some embodiments, the carbon nanotube ink can comprise a non-dopant binder concentration from about 0.025 to about 5 weight percent. In general, any polymer soluble in the select solvent can be used as a polymer dispersant, such as polyvinyl acetate, polyvinyl alcohol, or the like.

In some embodiments, the CNT based ink for some coating processes can have a viscosity from about 0.5 centipoise (cP) to about 500 cP, in further embodiments from about 1 cP to about 400 cP and in additional embodiments from about 5 cP to about 250 cP. A person of ordinary skill in the art will recognize that additional ranges of viscosity within the explicit ranges above are contemplated and are within the present disclosure. For other printing or coating processes, the inks can be designed over alternative viscosity ranges based on the compositions described herein.

### Processing

The carbon nanotube inks of interest herein are formed from good dispersions of carbon nanotubes. A good dispersion has nanotubes that are stable with respect to avoidance of settling over a reasonable period of time, generally at least one day, and in some embodiments at least 30 days, without further mixing. A good dispersion can be desirable with respect to both the electrical and optical properties of films formed the carbon nanotube inks. However, due to short-range intermolecular interactions (such as, for example, van der Waals interactions), however, carbon nanotubes are not inherently dispersible. In particular, the short-range intermolecular interactions can cause the nanotubes to generally orient parallel to each other to form ropes. In particular, undesirable amounts of carbon nanotube agglomeration can cause an undesirable reduction in film conductivity and can also lead to an undesirable increase in light scattering from films made therefrom.

The carbon nanotubes can be debundled by dispersing the carbon nanotubes by mechanical or chemical means. Mechanical dispersing of nanotubes by high-energy sonication and/or ball-milling is described in U.S. Pat. No. 6,280,697 to Zhou et al., entitled “Nanotube-Based High Energy Material and Method,” incorporated herein by reference. However, the use of these techniques can cause damage to the carbon nanotube side-walls and, therefore, can undesirably affect nanotube conductivity as well as the conductivity of films from therefrom. Furthermore, the use of dispersing methods generally shortens the lengths of the carbon nanotubes which can also have an undesirable effect on the conductivity of carbon nanotube composites made the carbon nanotubes.

Nanotube ropes can also be debundled using more benign techniques that reduce damage to the nanotubes. In particular, the control of sonication conditions can be selected to reduce damage, and centrifugation can be performed on the sonicated nanotube dispersion to separate nanotube bundles from well dispersed debundled nanotubes, and the supernatant from the sonication process can be used for further processing into the electrically conductive inks. The combination of sonication under controlled conditions with centrifugation to separate the well dispersed nanotubes from remaining nanotube bundles provides for forming an ink with nanotubes with reduced damage at some expense of yield. The use of FWNTs and/or DWNTs may provide for better debundling with reduced damage and greater yield. Furthermore, polymer dispersants, such as perfluorinated/persulfonated polymers, have been found to be excellent dispersants for carbon nanotubes in polar solvents including, for example, aqueous, e.g., water, or alcohol-based solvents.

In some embodiments the carbon nanotubes can be first dispersed in the alcohol-based solvent and the other ink components can be subsequently added and mixed with the dispersed carbon nanotubes. In other embodiments, a homogeneous solution of the ionic dopant and solvent can be formed prior to subsequent dispersion of the carbon nanotubes in the homogeneous solution. Other components of the carbon nanotube ink can be added to the homogenous solution prior to or after subsequent dispersion of the carbon nanotubes. For example, in one embodiment, the ionic dopant, alcohol-based solvent and a dopant dispersant is first mixed to create a homogeneous solution and carbon nanotubes are subsequently added to the homogeneous solution and dispersed. Additives, such as non-dopant dispersants, can be similarly added to the dispersion.

In general, non-sulfonated surfactants, in addition to or as an alternative to sulfonated surfactants, can be helpful in adjusting the surface tension of an ink for a particular printing approach. The surface tension of the ink can be selected to influence the wetting or beading of the ink onto the substrate surface following deposition of the ink. In some embodiments with optional surfactants, such as SDS, surfactants are introduced into the dispersion in amounts of no more than about 2 weight percent and in other embodiments no more than about 1 weight percent. A person of ordinary skill in the art will recognize that additional ranges of surfactant within the explicit ranges above are contemplated and are within the present disclosure.

Viscosity modifiers can be added to alter the viscosity of the dispersions. The viscosity is a measure of the deformation of fluid in response to an applied shear stress. The viscosity of the ink can be selected by the addition of viscosity modifiers and/or by adjusting the carbon nanotube concentration in the ink. Other potential additives include, for example, pH adjusting agents, antioxidants, UV absorbers, antiseptic agents and the like. These additional additives are generally present in amounts of no more than about 1 weight percent. A person of ordinary skill in the art will recognize that additional ranges of surfactant and additive concentrations within the explicit ranges herein are contemplated and are within the present disclosure.

The inks can be deposited on a substrate by suitable coating and/or printing techniques. In some embodiments, coating methods can be selected for forming uniform films. Suitable coating approaches for carbon nanotube inks include, for example, spin coatings, dip coating, spray coating, knife-edge coating, extrusion or the like. In further embodiments, printing methods can be generally desirable for forming patterns with high resolutions. Suitable printing techniques include, for example, screen printing, inkjet printing, lithographic printing, gravure printing and the like. Following deposition, the inks can be cured by heating to remove solvent and/or other volatile components in the carbon nanotube ink. Suitable substrates include, but are not limited to polymer sheets (films), glass, ceramics, or the like. Suitable polymer sheets include, for example, films comprising polyester, such as poly ethyleneterephthalate (PET) or poly ethylene naphthalate (PEN), polycarbonate (PC), polyimide (PI) or combinations thereof.

In general, following deposition, the liquid evaporates to leave the carbon nanotubes and any other non-volatile components of the inks remaining. In addition to other potential functions, polymer components can stabilize the films formed following the drying of the deposited material. Additionally or alternatively, a transparent polymer overcoat can be applied to protect the transparent, electrically conductive film. If the overcoat is sufficiently thin, the coated film can maintain a desired degree of transparency.

In general, a coating of the ink can have an average thickness of no more than about 1 micron and in some embodiments no more than about 500 nm. While the thickness can be roughly estimated from profilometry measurements or the like, it can be desirable to reference deposition coverage as an alternative or in addition. For example, the coating of the carbon nanotube ink can be formed with a coverage of no more than about 10 microliters per square centimeter (μl/cm²), in further embodiments from about 0.1 to about 8 μl/cm², and in other embodiments from about 0.25 to about 5 μl/cm². A person of ordinary skill in the art will recognize that additional ranges of thickness and coverage within the explicit ranges above are contemplated and are within the present disclosure.

### Electrically Conductive Transparent Films

The carbon nanotubes films as described herein have high transparency and low sheet resistance. The films can be coated onto a substrate or can be patterned to form desired structures on the substrate. Due to the relative high transparency and electrical conductivity, the carbon nanotube films can be desirably used in a range of application as noted above.

Generally, the transparency and sheet resistance are related to the thickness or loading of the film on a substrate surface such that as the film thickness or loading increases, both the transparency and the sheet resistance of the film can decrease. The design of a particular film can involve the balance of transparency and sheet resistance, and improved films described herein can involve significant improvements for the overall properties with a high optical transparency and a low sheet resistance. In some embodiments, the film has an average thickness of no more than about 1 microns; in other embodiments, from about 200 nm to about 500 nm, while still having desirable transparency and sheet resistance. A person of ordinary skill in the art will recognize that additional ranges of thicknesses within the particular ranges above are contemplated and are within the present disclosure.

The transparency of the films can be measured using a UV-Visible spectrophotometer, which are widely, commercially available from sources such as PerkinElmer, Inc. (San Jose, Calif.). To measure the transmittance of a film, a sample is formed by forming a film on a substrate that is relatively transparent to the range of wavelengths over which the transmittance of the sample is to be measured. The transmittance spectrum of the sample is then obtaining at a selected wavelength or wavelength range. For films of interest herein, high transmittance generally is desired over the range of visible wavelengths from about 390 nm to about 750 nm, but the transmittance of the films are measured at 550 nm for convenience.

To estimate the transmittance of the film itself, the transmittance of the bare substrate is obtained and decoupled from the transmittance obtained from the sample. Transmittance is the ratio of the transmitted light intensity (I) to the incident light intensity (Iₒ). The transmittance through the film (T_{film}) can be estimated by dividing the total transmittance (T) measured by the transmittance through the support substrate (T_{sub}). (T=I/Iₒ and T/T_{sub}=(I/Iₒ)/(I_{sub}/Iₒ)=I/I_{sub}=T_{film}, where I_{sub} is the light intensity transmitted through the substrate.) In some embodiments, the film has a transmittance over the range of visible wavelengths of at least 80% and in other embodiments, of at least 85%. Unless indicated specifically otherwise, a reference to transmission refers to transmission at 550 nm light. However, generally total transmission of visible light, which is specified to be the average transmission across the visible spectrum, is observed to be somewhat greater than the transmission at 550 nm, so that measurements at 550 nm are expected to be lower limits of total transmission values for the corresponding films. Transmission is measured using ASTM-D 1003 protocols. A person of ordinary skill in the art will recognize that additional ranges of transmittance within the particular ranges above are contemplated and are within the present disclosure.

The films described herein have a low sheet resistance. The sheet resistance can be measured using a four point probe. A four point probe measures resistivity by passing current through the film between a pair of outer probes and measuring the voltage between a pair of inner probes. The sheet resistance is then calculated as the measured resistivity divided by the thickness of the film. In some embodiments, the film can have a sheet resistance of no more than about 500Ω/□; in other embodiments, no more than about 400Ω/□ and in further embodiments, from about 100 to about 300Ω/□. In general, thicker films of CNTs can have a lower sheet resistance, but the transparency decreases. Thus, it can be desirable to be able to achieve simultaneously a low sheet resistance and a relatively high transparency, and desirable performance with respect to optical transparency and sheet resistance can be obtained with the materials described herein. Specifically, the specific ranges of values of sheet resistance can be obtained with the values of optical transparency in the preceding paragraph. A person of ordinary skill in the art will recognize that additional ranges of sheet resistances within the particular ranges above are contemplated and are within the present disclosure.

The coating and/or printing approaches described above can be used to coat the substrate or pattern it with a carbon nanotube ink. In some embodiments, the ink is printed/coated onto a substrate to cover the entire substrate surface roughly uniformly. In other embodiments, the ink is printed/coated locally onto only a portion or portions of the substrate surface. With respect to coating approaches, a mask can be used to deposit ink locally, such as in a screen printing format. The locally deposited inks can form islands which can function as, or be further processed into, a device component. In some embodiments, a plurality of printing/coating steps is used. Each printing/coating step may or may not involve a patterning. The ink may or may not be dried or partially dried between the respective coating and/or printing steps. Sequential patterned printing steps generally involve the deposition onto an initially deposited ink material. The subsequent deposits may or may not approximately align with the initially deposited material, and further subsequently deposited patterns of material may or may not approximately align with the previously deposited layers. Following deposition, the deposited material can be further processed into a desired device or structure.

The films of the present invention can be desirable for a variety of application including, but not limited to, transparent electrodes, electrostatic discharge shielding. As a transparent film, the films can be incorporated into a variety of devices such as LED and LCD display panels and photovoltaic elements. With respect to incorporation within a display panel, the film can be incorporated as an electrode within the diode structure of the display. In such configurations, the film can be deposited onto an emissive and/or conductive layer within the diode structure. With respect to photovoltaic devices, the film can be incorporated as a front-side current collector for harvesting current.

### EXAMPLES

### Example 1

### Electrical Properties of CNT Films

The following Examples demonstrate the improved electrical conductivity (lower resistivity) properties of transparent conductive films composed carbon nanotubes with improved dopants.

The following example exhibits, through three different cases, the synergistic improvement of the carbon nanotube (CNT) based film using both a polymer dispersant with doping ability combined with an inorganic salt dopant. In this Example, “dopant” refers to the inorganic salt dopant. To demonstrate improved electrical properties, 3 sets of film samples were formed from the inks. Film sample sets Case 1-3 were formed from ink samples 1-3 (Table 1), respectively. In general, the CNTs powder was used as received from a commercial supplier, although in some cases acid or thermal purification was used to remove impurities from the powder. The CNTs were in the form of primarily double walled nanotubes (DWNT), with at least about 75% of the nanotubes being double walled. The diameter range of the nanotubes was 1 nm to 5 nm, with average length varying substantially in the dry powder state from ˜10 μm to several 100 μm. Polymer/dispersants and dopants were used as received from Sigma-Aldrich without further purification.

The concentration ranges for each example composition are found in Table 1. In all cases ultrasonication time was between 10-80 minutes, and the centrifuge conditions were 5,000-20,000 RPM for 2-60 minutes.

TABLE 2

| | Ink Type | | |
|---|---|---|---|
| Component | Case 1 | Case 2 | Case 3 |
| Nanotube (wt %) | 0.1-0.5 | 0.1-1.0 | 0.1-1.0 |
| Solvent Type | NMP | Alcohols | Alcohols |
| Sulfonic acid or PFSA | 0 | 1.5-3.9 | 1.5-3.9 |
| polymer (wt %) | | | |
| Ionic Dopant (mg/ml) | 0 | 0 | 0.01-2 |

CASE I. Without polymer Dispersant or Other Dopant.

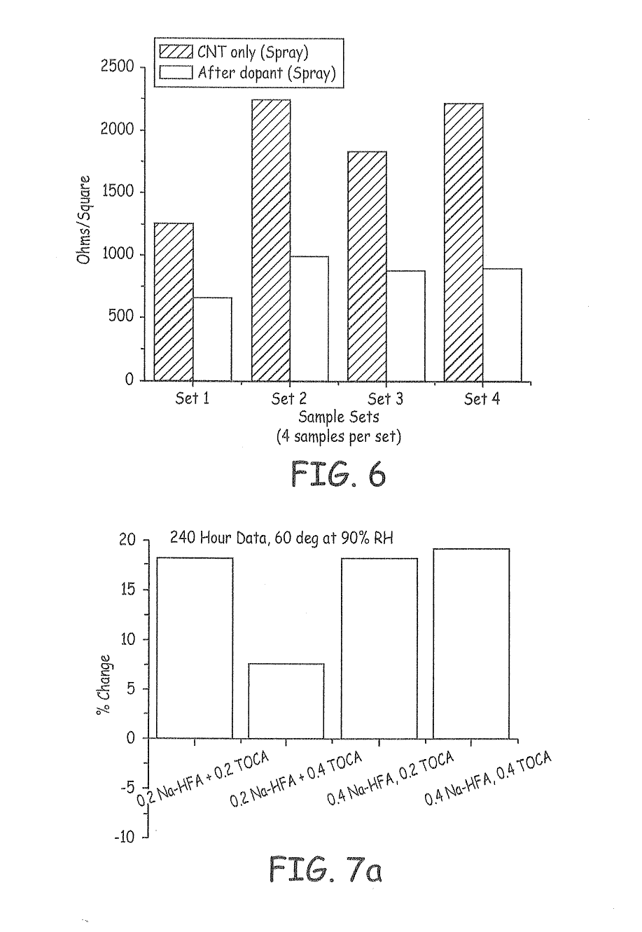

Carbon nanotubes (CNTs) in the form of a dry powder, paper, or wet cake were first dispersed into an organic solvent that was n-methyl-2-pyrrolidone (NMP) without additional dispersant. CNTs were dispersed into NMP at 0.1wt % to 0.5 wt % via ultrasonication to produce a “conductive ink”. The sonicated ink was then centrifuged to remove any large bundles and impurities. The supernatant was then collected and used as the final conductive ink for further processing. The conductive ink was then coated out onto a PET film at a transmittance (% T at 550 nm) of 83-87% including the substrate, as measured with a UV-Visible spectrophotometer. In this case, the film had a sheet resistance value of ˜1000-3000Ω/□ (Table 2). Surface resistances displayed in Table 2 were measured by a 4 point probe. However, in this case, the independent doping effect of just the non-dispersant ionic dopant alone as listed in Table 1 can be observed in FIG. 6. In a typical experiment here, the dopant molecule (in this case, Ag-HFA or TOCA) is dissolved in alcohol or water based solvents at similar concentrations as the dopant molecule concentrations listed in Case III (0.01-2 mg/ml). The dopant is then applied by spray coating this dopant solution onto the bare (dispersant-free) CNT network, and the change in resistivity is noted. The two ionic dopants gave similar improvements in resistivity.

CASE II. With polymer Dispersant.

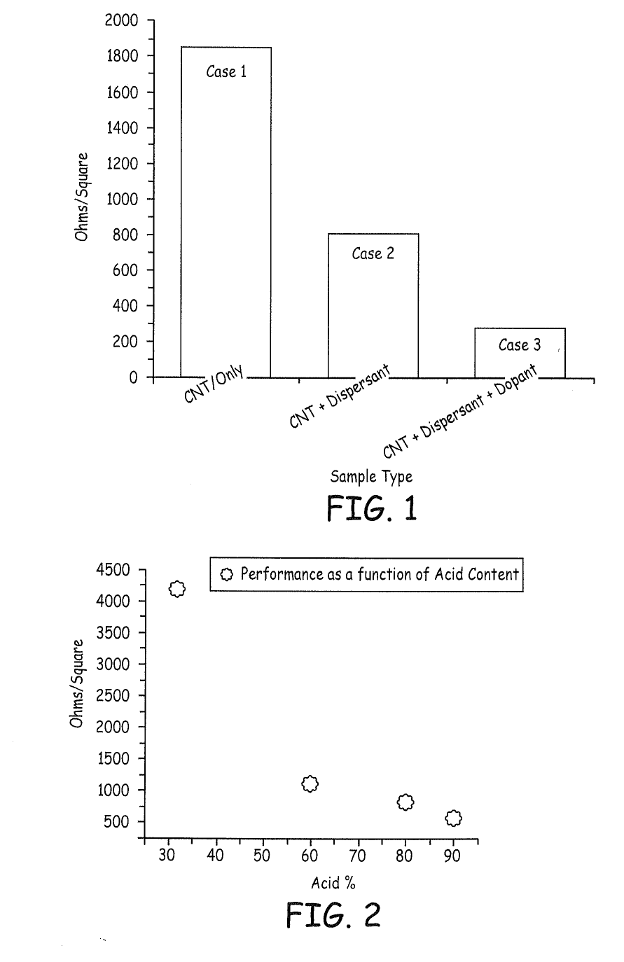

Carbon nanotubes (CNTs) in the form of a dry powder, paper, or wet cake were first dispersed into an organic solvent that was either ethanol or isopropyl alcohol. In this Case, the CNTs were dispersed using a sulfonic acid based polymer or perfluorinated sulfonic acid (PFSA) polymer that was added to the CNT and organic solvent mixture. In this Case, the CNT wt % was from 0.1 wt % to 1%, and the sulfonic acid based polymer concentration was 1.5 wt % to 3.9 wt %. The CNTs were dispersed via ultrasonication, followed by centrifuging and collection of the supernatant to be used as the final conductive ink for coating. The conductive ink was then coated out onto a PET film at a transmittance (% T at 550 nm) of 83-87% including the substrate. In this case, the film had a sheet resistance value of ˜700-1000Ω/□, which is at least 50% better, i.e., lower, than without the sulfonic acid based polymer dispersant with average results plotted in FIG. 1, which is believed to be due to the doping of CNTs with sulfonic acid moieties.

To demonstrate the effect of acid concentration, several samples were prepared as described above with different polymer properties at the same weight percent of the polymer. Results were obtained as a function of molecular weight in thousands g/mole and percent of acid groups for perfluorosulfonic acid copolymers. As shown in FIG. 2, the electrical conductivity is found to improve with an increase in the percent acid groups based on a fixed total weight percent of polymer dispersant. In particular, at greater than about 50% acid groups, excellent results are obtained. However, with high acid content, film stability, as determined by changes in electrical conductivity, may decrease under conditions of high temperature and high humidity (65° C. at 90% RH).

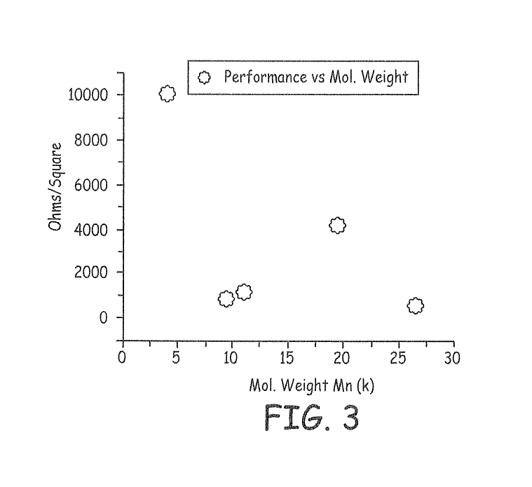

The sheet resistance as a function of molecular weight of the polymer dispersant is shown in FIG. 3. The number average molecular weight (Mₙ) of the dispersant can have an optimal value, which can typically be the lowest Mₙ value that allows for a completely dispersed (debundled) CNT ink. Excessive dispersant material, which is typically insulating, may only lead to increased resistivity between individual CNTs within the network film, as shown in FIG. 3. Referring to the figure, a range of polymer from Mₙ=4,000-26,000 g/mole are sampled, and lowest sheet resistance is achieved around 10,000 g/mole. The data point at 26,000 g/mole does not follow this trend, however this dispersant also has a much higher acid content that compensates for the conductivity lost through the excess molecular weight.

CASE III. With polymer Dispersant and Dopant.

Carbon nanotubes (CNTs) in the form of a dry powder, paper, or wet cake are first dispersed into an organic solvent that was either ethanol, isopropyl alcohol, 1-methyl-2-propanol, water or the like. In this example, the CNTs were dispersed using a sulfonic acid based polymer or perfluorinated sulfonic acid (PFSA) polymer that was added to the CNT and organic solvent mixture as described above in the second example. Again, in this Case, the CNT concentration was from 0.1 wt % to 1 wt %, and the polymer concentration was 1.5 wt % to 3.9 wt %. In some samples formed in this Case, dopant salt is also mixed in at this step (before ultrasonication) with the PFSA/sulfonic acid based polymer, and the entire solution (CNT+solvent+polymer+dopant) is ultrasonicated together. In other samples formed in this Case, the dopant is added after the CNT+solvent+polymer solution is ultrasonicated and centrifuged. The concentration of the dopant ranges from 0.2-2 mg/ml.

The conductive ink was then coated out onto a PET film at a transmittance (% T at 550 nm) of 83-87% including the substrate. In this Case, the film had a sheet resistance value of ˜200-500Ω/□, which is more than 50% better than Case II with the sulfonic acid based polymer dispersant (Table 2) without dopant. Thus, adding the dopant provides additional conductivity enhancement of the CNT network beyond the sulfonic acid based polymer alone.

The dopants include materials that are one-electron oxidants, inorganic salts having a monovalent metal cation and a polyatomic halogenated inorganic anion, fluorinated fullerenes or a combination thereof. Specific families of dopants may include, but are not limited to, hexachloroantimonates, hexafluoroantimonates, trifluoromethane sulfonimides, trifluoromethanesulfonates. Specific families of the fluorinated fullerenes may include, but are not limited to, C₆₀Fₓ, and C₇₀Fₓ, where x is between 18 and 54. A list of specific fluorinated fullerenes that are suitable for use as dopants for CNTs are found in Table 1 above.

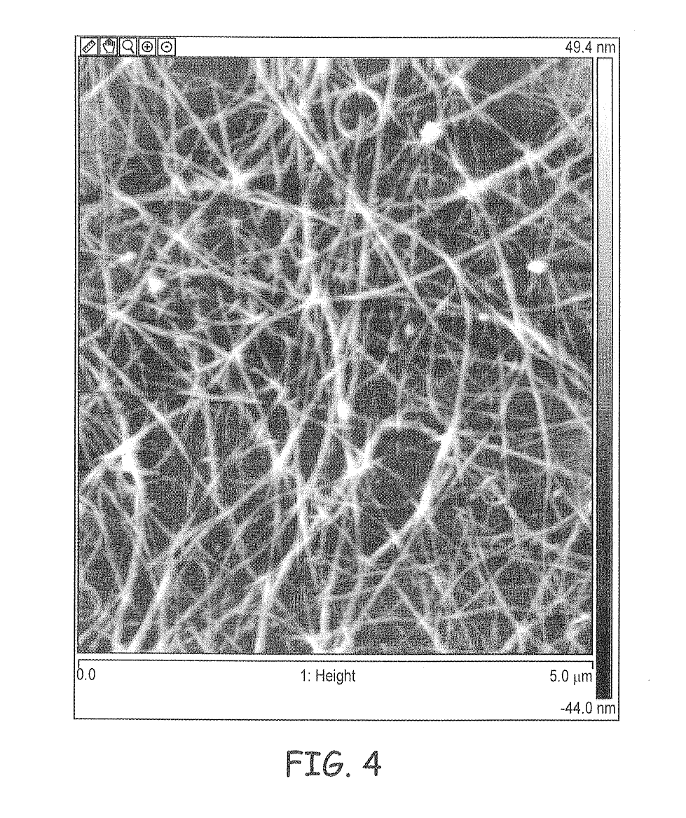

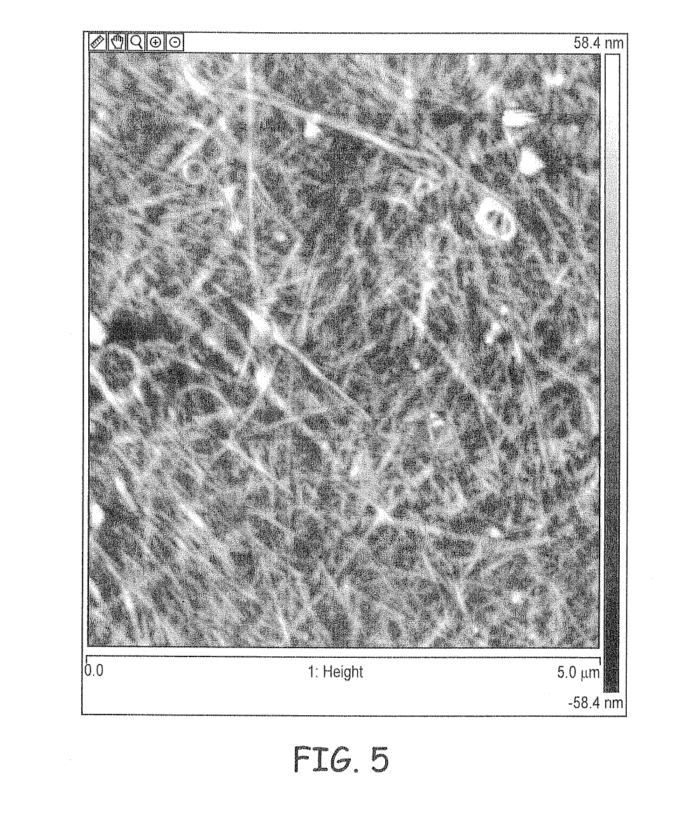

The deposited films had an average thickness of about 40-100 nm as estimated by the level of transparency, as well as Atomic Force Microscopy (“AFM”) images. Observation of the data presented in FIG. 1 reveals that the films from Case 1 have performance significantly worse than the data in the other cases. Film samples formed from the inks comprising PFSA/sulfonic acid based polymer dispersant demonstrated improved uniformity, CNT debundling, and fill factor relative to the films formed from the ink that did not comprise the polymer dispersant. FIGS. 4 and 5 are AFM images showing a top view of the film coated surface of representative film samples from Cases 1 (no dispersant) and Case 2 (polymer dispersant), respectively. Comparison of the figures reveals that the film sample from Case 2 was smoother, demonstrating an improved fill factor and less bundling relative to the film sample from Case 1. This result suggests that the ink samples comprising PFSA/sulfonic acid based polymer (inks from Cases 2 and 3) had improved dispersability and coatability relative to the ink samples without polymer dispersant (ink from Case 1), and both of these characteristics resulted in higher performance of the resulting film.

Furthermore, the presence of dopant did not appreciably affect the morphology of the film. This result suggests that dopant presence in the film sample from Case 3 did not significantly interfere with the ability of PFSA/sulfonic acid based polymer to function as a dispersant in the ink. In addition, the coatability of the conductive ink is enhanced by the addition of the dopant.

Average results from the three cases are plotted in FIG. 1. Overall, results presented in FIG. 1 demonstrate that, on average, the samples from Case 1 had a significantly greater surface resistance relative to the samples from Case 2 and that the samples from Case 2 had a significantly greater surface resistance relative to the samples from Case 3. In particular, comparison of the results obtained for sample Cases 1 and 2 demonstrate the film samples comprising dispersant dopant (PFSA/sulfonic acid based polymer) (Case 2) had decreased sheet resistance relative to the film samples without (Case 1), which is consistent with the dopant functionality of the PFSA/sulfonic acid based polymer. Moreover, film samples further comprising 0.2-2 mg/ml dopant in addition to PFSA/sulfonic acid based polymer further decreased sheet resistances, as shown in FIG. 1. These results demonstrate not only the ability of PFSA/sulfonic acid based polymers to function as a dopant, but that the addition of dopants including metal hexachloroantimonates, metal hexafluoroantimonates, trifluoromethane sulfonimides, and trifluoromethanesulfonates can further decrease the sheet resistance of films formed, even though the PFSA/sulfonic acid based polymer is already functioning as a dopant, thereby demonstrating the unique synergistic doping combination of PFSA/sulfonic acid based polymer+dopant disclosed herein.

### Example 2

### Electrical Properties of CNT Films—Dopant Combinations

This example demonstrates the effects of dopant combinations. In particular, this Example demonstrates the effects of dopant combinations on environmental stability of inks and films formed therefrom by the addition of a dopant source that can also function as a stabilizing agent. All of the samples in this Example comprised 1-5 wt % PFSA in addition to the other specific dopants.

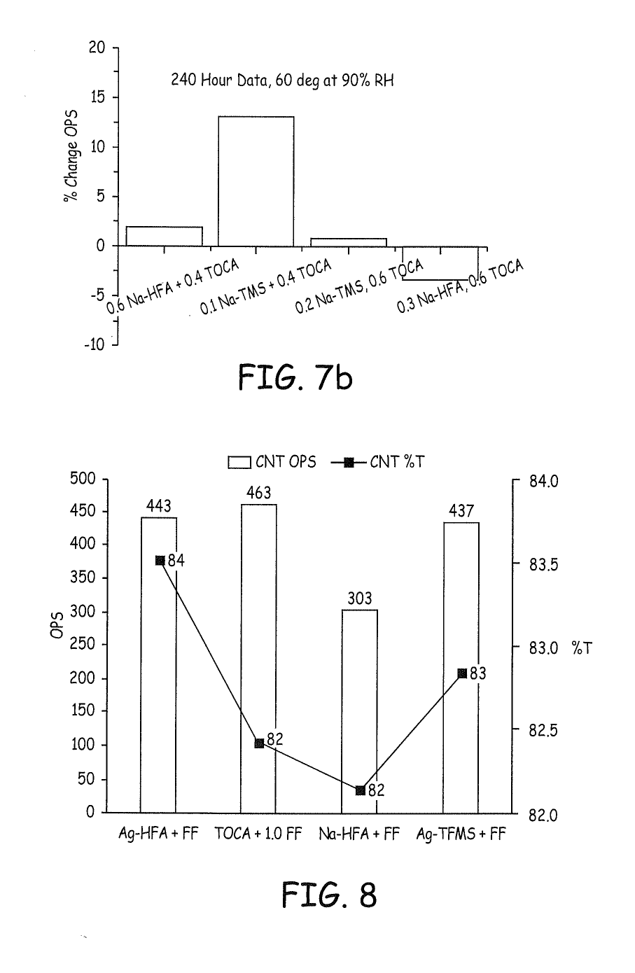

To demonstrate stability, 8 samples were formed with a combination of 2 dopants. One dopant was either sodium hexafluoroantimonate (“Na-HFA”) or sodium trifluoromethansulfonates (“Na-TMS”) and the second dopant was triethyloxonium-hexachloroantimonate (“TOCA”). The first dopant was intended to function as a stabilizing agent, to promote stability of the samples under humid environmental conditions, 90% relative humidity and 60° C., for 240 hours. The concentration of each dopant in each sample is indicated in FIGS. 7a and 7b (in mg/ml). Environmental stability was measured as the relative change in surface resistance of each film sample when measured under humid environmental conditions. The sheet resistance results are displayed in FIGS. 7a and 7b.

Referring to FIGS. 7a and 7b, all of the samples demonstrated less than 20% relative change in surface resistance (ohms per square, “OPS”, as used in FIGS. 7a and 7b). In fact, some of the samples showed a negative relative change in surface resistance, indicating decreased surface resistance at “extreme” environmental conditions. The negative relative change may be a result of doping from the environment (water can p-dope CNTs), although this has not been confirmed. To further elucidate the role of the stabilizing agents, several samples were also formed as described above, however, using a single dopant comprising TOCA. Generally it was observed that as the concentration of TOCA increased, performance increased but the stability tended to decrease (results not shown). On the other hand, it was found that addition of the stabilizing agents (Na-HFA, NaTMS) tended to add stability, but decreased performance, as shown in FIG. 7.

Table 3 lists typical examples of dopant combinations that provide for the samples tested the 1) low sheet resistance performance (not shown) combined with the 2) high stability (data partially shown in FIGS. 7a and 7b). “FF” refers to fluorinated fullerenes as is discussed below.

TABLE 3

| Dopant 1 | Dopant 2 |
|---|---|
| TOCA | Na-HFA |
| | Li-TMS |
| | Na-TMS |
| FF | Na-HFA |
| | Ag-TMS |
| | Na-TMS |
| | Ag-HFA |
| | TOCA |

To demonstrate improved electrical conductivity (lower resistivity) properties of transparent conductive films composed of carbon nanotubes with dopants comprising fluorinated fullerenes and halogenated inorganic dopant, 7 additional samples were formed as described above with the exception that one dopant component comprised fluorinated fullerenes and a second dopant component. The stabilizing dopant comprised silver hexafluoroantimonate (“Ag-HFA”), TOCA, or Na-HFA. The concentrations of each dopant component in each sample are displayed in FIG. 8 in mg/ml.

FIG. 8 is a graph of sheet resistance in ohms per square (OPS) and percent transmittance versus sample. Referring to FIG. 8, the sample prepared with 0.5 Na-HFA and 0.5 FF (fluorinated fullerenes) demonstrated excellent sheet resistance and percent transmittance. Without being limited by a theory, it is believed that the FF can become de-stabilized in combination with PFSA dispersants as a result of the acidic functionality of the PFSA dispersants, thus the combination of the Na-HFA can provide desirable stabilization effects. In particular, again without being limited by a theory, it is believed that the monovalent salts can neutralize the free acid groups on or PFSA dispersants, thus reducing the reactivity towards FF and stabilizing the ink formulation.

### Example 3

### Polymer Dispersant Concentration

This Example demonstrates the effect of polymer dispersant concentration on the sheet resistance of films formed from nanotube inks comprising polymer dispersant.

To demonstrate the effect of polymer dispersant concentration, 3 sets inks sample sets were used to form 3 corresponding sample film sets, substantially as described in Case III of Example 1 (CNT+solvent+polymer dispersant+ionic dopant). For each ink sample set, the polymer dispersant comprised perfluorinated sulfonic acid (PFSA). For ink sample sets 1-3, the inks comprise 1 mg/ml of the ionic dopant. The ink samples within each set were formed with different amounts of polymer dispersant, while keeping the amount of the remaining ink components constant. In particular, the dispersant concentration among the different samples in each set ranged about 1.3 volume percent (vol %) to about 2.7 vol %. At some polymer dispersant concentrations, multiple ink samples were formed to determine the spread in sheet resistances from films made there from. Each film made from the various ink samples had a transmittance of about 84% at 550 nm including the substrate (PET).

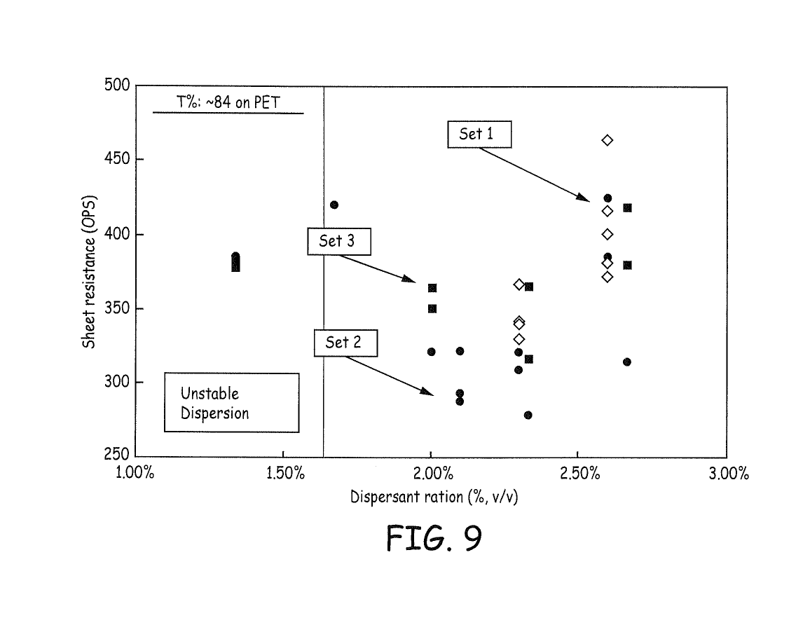

The results of the sheet resistance measurements on the films formed from the various ink samples are displayed in FIG. 9. Referring to the figure, at below about 1.50 vol % dispersant, the film samples had roughly the same sheet resistances (about 375Ω/□t this polymer dispersant concentration, the ink samples used to form the films were unstable (i.e. the CNTs did not remain suspended in the ink) and, therefore, the increased sheet resistances observed relative to some of the corresponding films formed from ink comprising stably dispersed CNTs (i.e. films formed from ink samples comprising greater than about 1.6 vol % polymer dispersant) suggest that stable dispersions lead to better electrical conductivity. Generally, between about 2.0 vol % and about 2.4 vol % polymer dispersant, the film samples had lower sheet resistances relative to the other corresponding film samples but, surprisingly, above about 2.5% vol percent polymer dispersant, the sheet resistances of the films generally significantly increased. In particular, the films formed from ink samples comprising more than about 2.5 vol % polymer dispersant had the highest sheet resistances of all other corresponding samples. This demonstrates that, for the films tested, above a certain polymer dispersant concentration, the sheet resistance of a film can increase, despite the increased dopant concentration (i.e. polymer dispersant dopant).

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. An ink for the formation of a transparent electrically conductive film coating comprising:
an alcohol based solvent or water based solvent,
from about 25 to about 2000 micrograms/milliliter (μg/ml) well dispersed carbon nanotubes,
from about 0.025 to about 5 weight percent sulfonated dispersant comprising a sulfonate (—SO₃) functional group and having a molecular weight of at least about 250 g/mole, and
from about 0.1 to about 10 milligrams/ml (mg/ml) an ionic dopant composition, fluorinated fullerenes or a combination thereof, wherein the ionic dopant composition comprises a perhalogenated inorganic anions, trifluoromethylsulfonimide anions, trifluoromethanesulfonate anions or combinations thereof.

2. The ink of claim 1 wherein the alcohol comprises ethanol, isopropyl alcohol, 2-butanol, isobutanol or a mixture thereof.

3. The ink of claim 1 wherein the sulfonated dispersant is perfluorinated

4. The ink of claim 1 wherein the sulfonated dispersant comprises a surfactant.

5. The ink of claim 1 wherein the sulfonated dispersant comprises a polymer.

6. The ink of claim 1 wherein the polymer has a molecular weight from about 5000 g/mole to about 30,000 g/mole.

7. The ink of claim 1 further comprising an additional polymer that is not sulfonated.

8. The ink of claim 1 wherein the carbon nanotubes comprise at least about 60 number % few wall carbon nanotubes, double wall carbon nanotubes or a combination thereof having an average diameter from about 1 nm to about 10 nm and an average length from about 250 nm to about 12 microns.

9. The ink of claim 1 wherein the ionic dopant composition comprises OSbCl₆, where O is a trialkyloxonium, sulfonium, iodonium cation or combinations thereof.

10. The ink of claim 1 wherein the ionic dopant composition comprises MSbF₆, where M is a monovalent metal cation.

11. The ink of claim 1 wherein the ionic dopant composition comprises AgSbF₆, AgSbCl₆, AgBF₄, AgBCl₄ , AgPF₆, AgPCl₆ or a combination thereof.

12. The ink of claim 1 having from about 0.025 wt % to about 10 wt % carbon nanotube, from about 0.1 to about 2 weight percent perfluorinated sulphonated polymer and from about 0.1M to about 2M ionic dopant composition.

13. The ink of claim 1 having a viscosity range of 0.5 to 500 cP.

14. An ink for the formation of a transparent electrically conductive film coating comprising an aqueous based solvent or an alcohol based solvent, from about 0.025 wt % to about 5 wt % well dispersed carbon nanotubes and from about 0.01 wt % to about 2wt % inorganic salt comprising MSbF₆, MSbCl₆, MBF₄, MBCl₄, MPF₆, MPCl₆ or a combination thereof, where M is a monovalent metal cation.

15. An ink for the formation of a transparent electrically conductive film coating comprising an alcohol based solvent comprising at least about 85 volume % alcohol, from about 0.025 wt % to about 5 wt % well dispersed carbon nanotubes and from about 0.01 wt % to about 2wt % dopant comprising trifluoromethanesulfonate anions or trifluoromethanesulfonimide anions.

16. A transparent electrically conductive film comprising a layer having carbon nanotubes and an ionic dopant composition with a perhalogenated anion with at a weight ratio of nanotubes to ionic dopant composition from about 0.01 to about 1, wherein the layer has an average thickness from about 2 nanometers (nm) to about 250 nm, a surface resistance of no more than about 500 ohms/sq., and a percent transmission through the film at 550 nm of at least about 85%.

17. The transparent electrically conductive film of claim 16 wherein the layer further comprises from about 1 to about 75 weight percent of a sulfonated dispersing agent.

18. The transparent electrically conductive film of claim 16 wherein the layer further comprises a perfluorinated sulfonated dispersing agent.

19. The transparent electrically conductive film of claim 16 wherein the layer has a thickness from about 5 nm to about 100 nm.

20. The transparent electrically conductive film of claim 16 wherein the surface resistance is no more than about 100 ohms/sq. and the percent transmission of the film at 550 nm is at least about 90%.

21. The transparent electrically conductive film of claim 16 further comprising a non-conductive transparent polymer sheet having a surface in contact with the carbon nanotube layer.

22. The transparent electrically conductive film of claim 21 wherein the non-conductive transparent polymer sheet comprises polyester, polycarbonate or polyimide.

23. A device comprising a substrate and a transparent electrically conductive film of claim 21 wherein the film is in electrical connection with an electrode of the device.

24. The device of claim 23 wherein the device is a photovoltaic device.

25. The device of claim 23 wherein the device is a display device.

26. A method for the formation of a carbon nanotube ink, the method comprising:
forming a blend with a good dispersion of carbon nanotubes and an ionic dopant composition having a polyatomic halogenated inorganic anion, a trifluoromethanesulfonate, a trifluoromethanesulfonimide or a combination thereof.

27. The method of claim 26 further comprising sonicating double wall carbon nanotubes in an alcohol based solvent to form the good dispersion of nanotubes.

28. The method of claim 26 wherein the ink comprises from about 0.1 wt % to about 5wt % carbon nanotube and from about 0.2 to about 6 mg/ml ionic dopant composition.

29. The method of claim 26 further comprising combining a dispersion of a perfluorinated sulfonated polymer with the good dispersion of carbon nanotubes.

30. The method of claim 28 wherein the ink comprises from about 0.1 wt % to about 5wt % carbon nanotube, from about 0.1 to about 1 weight percent polymer and from about 0.2 to about 6 mg/ml ionic dopant composition.
